(19) United States
(12) Patent Application Publication
(10) Pub. No.: US 2026/0156367 A1
(43) Pub. Date: Jun. 4, 2026

(54) IMAGE PROCESSING DEVICE AND AUTO EXPOSURE CONTROL METHOD

(71) Applicant: SigmaStar Technology Ltd., Xiamen, Fujian (CN)

(72) Inventor: Ming Hui PENG, Taiwan (TW)

(21) Appl. No.: 19/371,255

(22) Filed: Oct. 28, 2025

(30) Foreign Application Priority Data
Nov. 29, 2024 (CN) 202411744792.3

(51) Int. Cl. H04N 23/73; H04N 23/76; H04N 25/583

(52) U.S. Cl. CPC H04N 23/73; H04N 23/76; H04N 25/583

(57) ABSTRACT

A controller outputs multiple different predetermined exposure control parameters to an image sensor during a first period after a device is powered on, such that the image sensor generates multiple sets of first frame data according to the predetermined exposure control parameters. An image processor generates multiple sets of statistical data based on the first frame data. A processor determines a first exposure control parameter according to the statistical data and outputs the first exposure control parameter to the image sensor via the controller, such that the image sensor generates second frame data according to the first exposure control parameter during a second period. A frame rate of each set of the first frame data is higher than that of the second frame data, and a resolution of each set of the first frame data is lower than that of the second frame data.

This application claims the benefit of China application Serial No. CN202411744792.3, filed on Nov. 29, 2024, the subject matter of which is incorporated herein by reference.

### BACKGROUND OF THE INVENTION

### Field of the Invention

The present application relates to an image processing device, and more particularly to an image processing device capable of improving auto exposure control efficiency and an auto exposure control method thereof.

### Description of the Related Art

In the prior art, an auto exposure control mechanism first generates a first frame by means of controlling an image sensor to determine an exposure parameter according to luminance information of a first frame, and then controls the image sensor to continue to generate a second frame according to the exposure parameter. Next, the auto exposure control mechanism updates the exposure parameter according to luminance information of the second frame, and controls the image sensor to generate a third frame according to the updated exposure parameter. Accordingly, the auto exposure control mechanism iterates the operation above so as to identify an exposure parameter appropriate for a current shoot scene. However, in the prior art above, all of the multiple frames captured have the same original predetermined frame rate and resolution, such that the overall time needed to generate the multiple frames above involves a longer period for computing, leading to less undesirable processing efficiency of auto exposure control.

### SUMMARY OF THE INVENTION

In some embodiments, it is an object of the present application to provide an image processing device capable of improving efficiency of auto exposure control and an auto exposure control method thereof, so as to overcome the drawbacks of the prior art.

In some embodiments, an image processing device includes a controller, an image processor and a processor. The controller sequentially outputs a plurality of predetermined exposure control parameters to an image sensor during a first period after the image processing device is powered on, such that the image sensor generates a plurality of sets of first frame data according to the plurality of predetermined exposure control parameters, wherein the plurality predetermined exposure control parameters are different from one another. The image processor generates a plurality of sets of statistical data based on the plurality of sets of first frame data. The processor determines a first exposure control parameter according to the plurality of sets of statistical data and outputs the first exposure control parameter to the image sensor via the controller, such that the image sensor generates second frame data according to the first exposure control parameter during a second period. A frame rate of each of the plurality of sets of first frame data is higher than that of the second frame data, and a resolution of each of the plurality of sets of first frame data is lower than that of the second frame data.

In some embodiments, an auto exposure control method performed by an image processing device includes: sequentially outputting a plurality of predetermined exposure control parameters to an image sensor during a first period after the image processing device is powered on, such that the image sensor generates a plurality of sets of first frame data according to the plurality of predetermined exposure control parameters, wherein the plurality of predetermined exposure control parameters are different from one another; generating a plurality of sets of statistical data based on the plurality of sets of first frame data; and determining a first exposure control parameter according to the plurality of sets of statistical data and outputting the first exposure control parameter to the image sensor, such that the image sensor generates second frame data according to the first exposure control parameter during a second period, wherein a frame rate of each of the plurality of sets of first frame data is higher than that of the second frame data, and a resolution of each of the plurality of sets of first frame data is lower than that of the second frame data.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of an image processing device according to some embodiments of the present application;

FIG. 2A is an operation flowchart of the image processing device in FIG. 1 according to some embodiments of the present application;

FIG. 2B is a flowchart of subsequent operations in continuation of FIG. 2A according to some embodiments of the present application;

FIG. 3A is an operation timing diagram of the image processing device in FIG. 1 according to some embodiments of the present application;

FIG. 3B is a schematic diagram of generating waveforms of multiple sets of frame data in FIG. 1 according to some embodiments of the present application;

FIG. 4A is a schematic diagram of a linear interpolation operation performed according to multiple sets of statistical data by the processor in FIG. 1 according to some embodiments of the present application;

FIG. 4B is a schematic diagram of a linear interpolation operation performed according to multiple sets of statistical data by the processor in FIG. 1 according to some embodiments of the present application;

FIG. 4C is a schematic diagram of a linear interpolation operation performed according to multiple sets of statistical data by the processor in FIG. 1 according to some embodiments of the present application; and

FIG. 5 is a flowchart of an auto exposure control method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

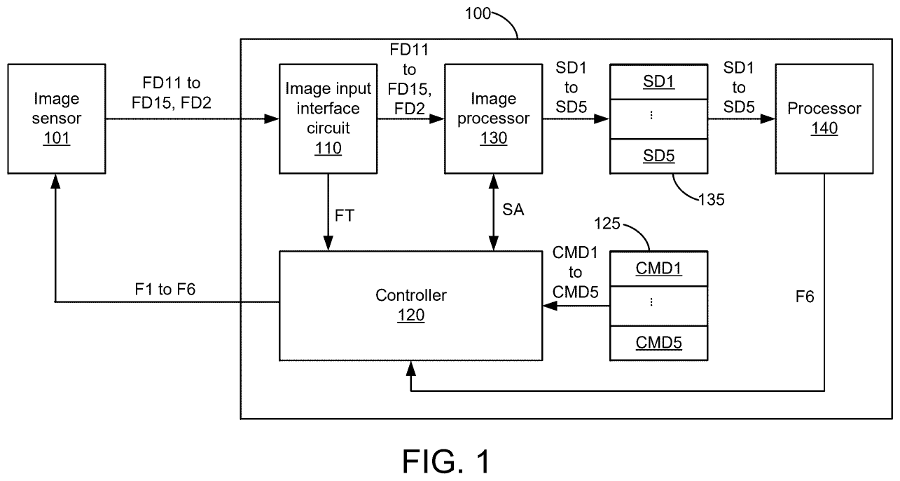

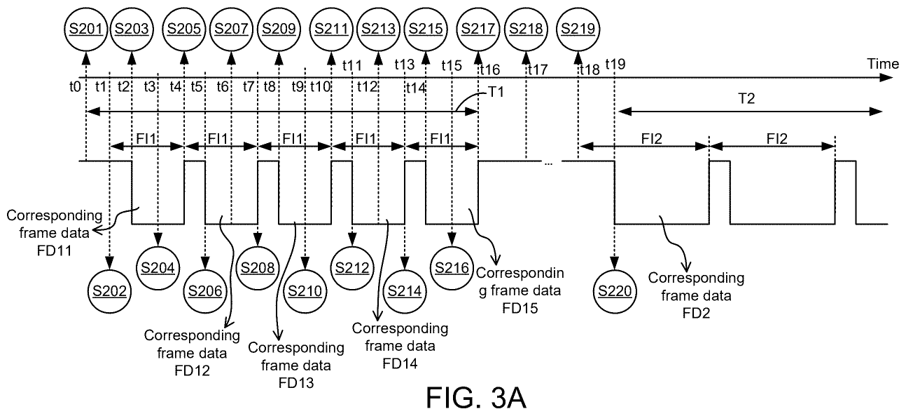

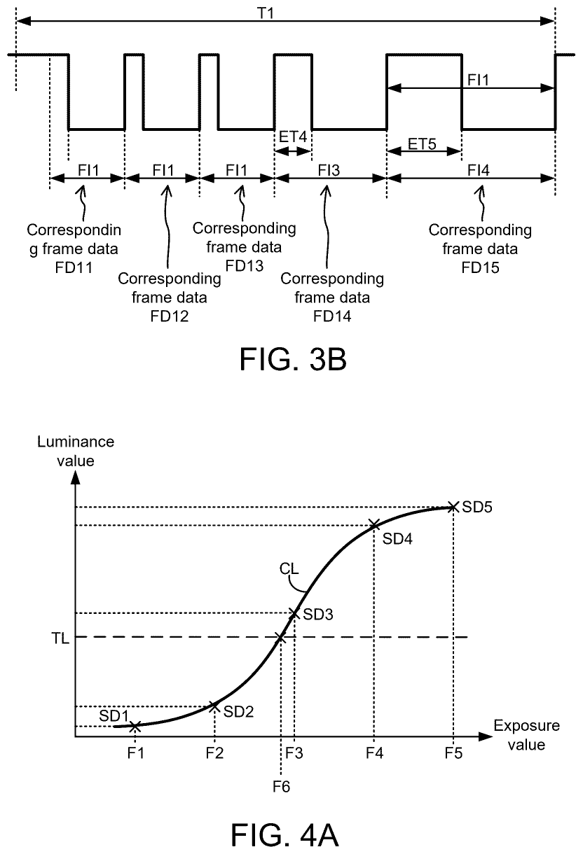

FIG. 1 shows a schematic diagram of an image processing device 100 according to some embodiments of the present application. In some embodiments, the image processing device 100 may configure an image sensor 101 by using multiple different predetermined exposure control parameters F1 to F5 during a first period (for example, a first period T1 in FIG. 3A) after being powered on, such that the image sensor 101 may sequentially generate multiple sets of frame data FD11 to FD15 according to the multiple different predetermined exposure control parameters F1 to F5 during the first period. Thus, the image processing device 100 may further determine an exposure control parameter F6 appropriate for the current environment according to the frame data FD11 to FD15, and configure the image sensor 101 by using this exposure control parameter F6 during a second period (for example, a second period T2 in FIG. 3A), such that the image sensor 101 may then accordingly generate frame data FD2 having a more appropriate exposure level. In some embodiments, each of the multiple predetermined exposure control parameters F1 to F5 and the exposure control parameter F6 may include configuration parameter information such as a shutter time (that is, an exposure time) of the image sensor 101, a gain of the image sensor 101 (and/or an image processor 130), and/or an aperture size of the image sensor 101.

More specifically, in some embodiments, the image processing device 100 may include an image input interface circuit 110, a controller 120, a command storage circuit 125, the image processor 130, a data storage circuit 135 and a processor 140. The image input interface circuit 110 is coupled to the image sensor 101 to receive frame data (for example, the multiple sets of frame data FD11 to FD15 and the frame data FD2 above) generated by the image sensor 101, and transmit the received frame data to the image processor 130. In some embodiments, during the process of transmitting the frame data, the image input interface circuit 110 may acquire frame synchronization timing information FT associated with the frame data, and provide the frame synchronization timing information FT to the controller 120. In some embodiments, the frame synchronization timing information FT includes, for example but not limited to, information such as a frame starting time, a frame ending time and/or a specific row number of the corresponding frame data. For example, during the process of transmitting the multiple sets of frame data FD11 to FD15 to the image processor 130, the image input interface circuit 110 may accordingly learn the frame synchronization timing information FT of each of the multiple sets of frame data FD11 to FD15, and may provide the frame synchronization timing information FT to the controller 120, such that the controller 120 may sequentially perform corresponding operations according to the timing information associated with the current frame.

The command storage circuit 125 may be a buffer, which stores multiple predetermined commands CMD1 to CMD5 executed during the first period above. The controller 120 may read from the command storage circuit 125 during the first period after the image processing device 100 is powered on so as to sequentially execute the multiple predetermined instructions CMD1 to CMD5. In some embodiments, each of the multiple predetermined commands CMD1 to CMD5 is for configuring the predetermined exposure control parameters F1 to F5 corresponding to the image sensor 101 and/or storage addresses (for example, address information SA to be described below) corresponding to the multiple sets of statistical data SD1 to SD5. The controller 120 may sequentially execute the multiple predetermined commands CMD1 to CMD5 according to the frame synchronization timing information FT above, so as to sequentially output the multiple predetermined exposure control parameters F1 to F5 to the image sensor 101 during the first period, and to configure the image sensor 101 to generate the multiple sets of frame data FD11 to FD15 according to the multiple different predetermined exposure control parameters F1 to F5. The predetermined exposure control parameters F1 to F5 are pre-configured and have different setting values from one another. That is to say, the multiple different predetermined exposure control parameters F1 to F5 are not generated according to the frame data output by the image sensor 101.

The image processor 130 may generate the multiple sets of statistical data SD1 to SD5 based on the multiple sets of frame data FD11 to FD15. For example, the image processor 130 may perform a luminance statistics operation according to the frame data FD11, so as to determine luminance information of the frame data FD11 and accordingly generate the statistical data SD1. In other words, the statistical data SD1 may be used to indicate the luminance information of the frame data FD11. Similarly, the image processor 130 may perform a luminance statistics operation according to the frame data FD12, so as to determine luminance information of the frame data FD12 and accordingly generate the statistical data SD2. Hence, the image processor 130 may perform a luminance statistics operation according to the multiple sets of frame data FD11 to FD15, so as to determine luminance information of the frame data FD11 to FD15 and accordingly generate the multiple sets of statistical data SD1 to SD5.

The data storage circuit 135 stores the multiple sets of statistical data SD1 to SD5. In some embodiments, the data storage circuit 135 may be a buffer; however, the present application is not limited to such example. On the basis of the multiple predetermined commands CMD1 to CMD5 executed by the controller 120, the image processor 130 may sequentially obtain the address information SA for storing each of the statistical data SD1 to SD5 in the data storage circuit 135. Thus, the image processor 130 may acquire the address information SA for corresponding data in the multiple sets of statistical data SD1 to SD5 before the corresponding data is generated. Accordingly, when the image processor 130 generates the corresponding data, the image processor 130 may store the corresponding data to a storage space corresponding to the address information SA in the data storage circuit 135 according to the address information SA. It should be noted that, timings at which the controller 120 executes the predetermined commands CMD1 to CMD5 may be asynchronous with timings at which the controller 120 transmits the address information SA corresponding to the statistical data SD1 to SD5.

The processor 140 is coupled to the data storage circuit 135 so as to acquire the multiple sets of statistical data SD1 to SD5. The processor 140 determines the exposure control parameter F6 according to the multiple statistical data SD1 to SD5, and outputs the exposure control parameter F6 to the image sensor 101 via the controller 120 during a second period following the first period. Thus, the image sensor 101 may generate the frame data FD2 having luminance information appropriate for the current environment according to the exposure control parameter F6 during the second period.

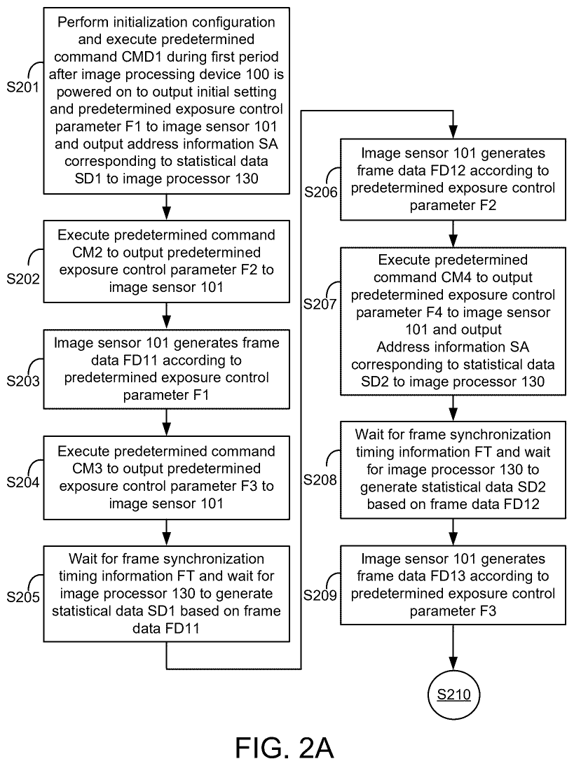

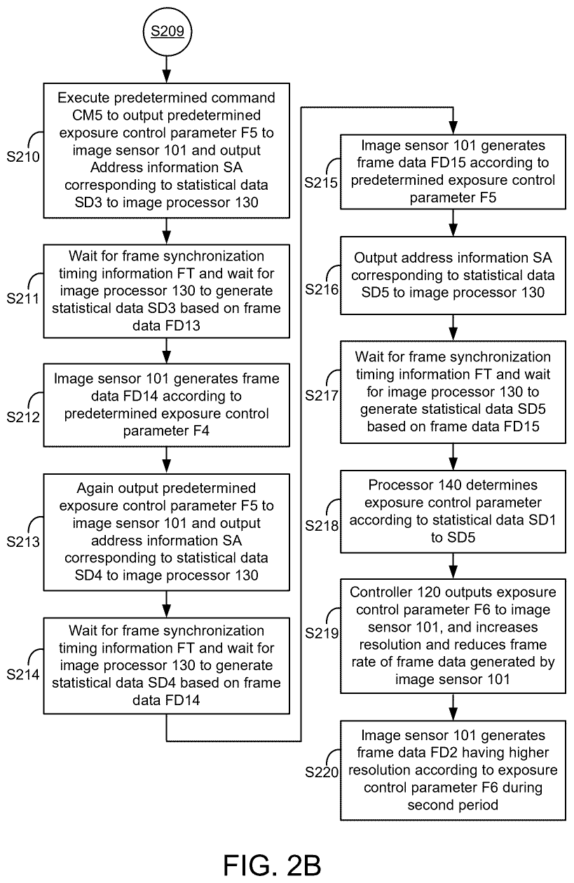

FIG. 2A shows a flowchart of operations of the image processing device 100 in FIG. 1 according to some embodiments of the present application. FIG. 2B shows a flowchart of subsequent operations in continuation of FIG. 2A according to some embodiments of the present application. FIG. 3A shows an operation timing diagram of the image processing device 100 in FIG. 1 according to some embodiments of the present application. For better understanding, multiple operations in FIG. 2A and FIG. 2B are described with reference to FIG. 1 and FIG. 3A below.

In operation S201, during the first period after the image processing device 100 is powered on, an initialization configuration is performed and the predetermined command CMD1 is executed, so as to output an initial setting and the predetermined exposure control parameter F1 to the image sensor 101 and output the address information SA corresponding to the statistical data SD1 to the image processor 130. For example, as shown in FIG. 3A, at a timing t0, the image processing device 100 is powered on, such that circuits (including, for example but not limited to, the image input interface circuit 110 and the image processor 130) in the image processing device 100 and the image sensor 101 undergo the initialization configuration. Once the initialization is complete, the controller 120 may read from the command storage circuit 125 to execute the predetermined command CMD1, output the predetermined exposure control parameter F1 to the image sensor 101 and output the address information SA corresponding to the statistical data SD1 to the image processor 130. It should be noted that, in different embodiments, the controller 120 may also transmit the address information SA corresponding to the statistical data SD1 to the image processor 130 at any of the timings t0 to t3.

In operation S202, the predetermined command CMD2 is executed to output the predetermined exposure control parameter F2 to the image sensor 101. For example, as shown in FIG. 3A, at a timing t1, the controller 120 may read from the command storage circuit 125 to execute the predetermined command CMD2 and output the predetermined exposure control parameter F2 to the image sensor 101.

In operation S203, the image sensor 101 generates the frame data FD11 according to the predetermined exposure control parameter F1. For example, as shown in FIG. 3A, at the timing t2, the configuration based on the predetermined exposure control parameter F1 takes effect, such that the image sensor 101 accordingly starts to generate the frame data FD11. In operation S204, the predetermined command CMD3 is executed to output the predetermined exposure control parameter F3 to the image sensor 101. The related operation timing corresponds to the timing t3 in FIG. 3A.

In operation S205, waiting for the frame synchronization timing information FT and for the image processor 130 to generate the statistical data SD1 according to the frame data FD11 is performed. For example, as shown in FIG. 3A, at a timing t4, the image input interface circuit 110 may output the frame synchronization timing information FT after the frame data FD11 ends, and the image processor 130 may accordingly generate the statistical data SD1 based on the frame data FD11 and store the statistical data SD1 to a corresponding position in the data storage circuit 135. In operation S206, the image sensor 101 generates the frame data FD12 according to the predetermined exposure control parameter F2. For example, as shown in FIG. 3A, at the timing t5, the configuration based on the predetermined exposure control parameter F2 takes effect, such that the image sensor 101 accordingly starts to generate the frame data FD12.

In operation S207, the predetermined command CMD4 is executed to output the predetermined exposure control parameter F4 to the image sensor 101 and output the address information SA corresponding to the statistical data SD2 to the image processor 130. The related operation timing corresponds to the timing t6 in FIG. 3A. In operation S208, waiting for the frame synchronization timing information FT and for the image processor 130 to generate the statistical data SD2 according to the frame data FD12 is performed. For example, as shown in FIG. 3A, at a timing t7, the image input interface circuit 110 may output the frame synchronization timing information FT after the frame data FD12 ends, and the image processor 130 may accordingly generate the statistical data SD2 based on the frame data FD12 and store the statistical data SD2 to a corresponding position in the data storage circuit 135 according to the address information SA corresponding to the statistical data SD2.

In operation S209, the image sensor 101 generates the frame data FD13 according to the predetermined exposure control parameter F3. For example, as shown in FIG. 3A, at the timing t8, the configuration based on the predetermined exposure control parameter F3 takes effect, such that the image sensor 101 accordingly starts to generate the frame data FD13. In operation S210, the predetermined command CMD5 is executed to output the predetermined exposure control parameter F5 to the image sensor 101 and output the address information SA corresponding to the statistical data SD3 to the image processor 130. The related operation timing corresponds to the timing t9 in FIG. 3A.

In operation S211, waiting for the frame synchronization timing information FT and for the image processor 130 to generate the statistical data SD3 according to the frame data FD13 is performed. For example, as shown in FIG. 3A, at a timing t10, the image input interface circuit 110 may output the frame synchronization timing information FT after the frame data FD13 ends, and the image processor 130 may accordingly generate the statistical data SD3 based on the frame data FD13 and store the statistical data SD3 to a corresponding position in the data storage circuit 135 according to the address information SA corresponding to the statistical data SD3. In operation S212, the image sensor 101 generates the frame data FD14 according to the predetermined exposure control parameter F4. For example, as shown in FIG. 3A, at the timing t11, the configuration based on the predetermined exposure control parameter F4 takes effect, such that the image sensor 101 accordingly starts to generate the frame data FD14.

In operation S213, the predetermined exposure control parameter F5 is again output to the image sensor 101 and the address information SA corresponding to the statistical data SD4 is output to the image processor 130. The related operation timing corresponds to the timing t12 in FIG. 3A.

In operation S214, waiting for the frame synchronization timing information FT and for the image processor 130 to generate the statistical data SD4 according to the frame data FD14 is performed. For example, as shown in FIG. 3A, at a timing t13, the image input interface circuit 110 may output the frame synchronization timing information FT after the frame data FD14 ends, and the image processor 130 may accordingly generate the statistical data SD4 based on the frame data FD14 and store the statistical data SD4 to a corresponding position in the data storage circuit 135 according to the address information SA corresponding to the statistical data SD4.

In operation S215, the image sensor 101 generates the frame data FD15 according to the predetermined exposure control parameter F5. For example, as shown in FIG. 3A, at a timing t14, the configuration based on the predetermined exposure control parameter F5 takes effect in operation S210, such that the image sensor 101 may accordingly start to generate the frame data FD15. In operation S216, the address information SA corresponding to the statistical data SD5 is output to the image processor 130.

In operation S217, waiting for the frame synchronization timing information FT and for the image processor 130 to generate the statistical data SD5 according to the frame data FD15 is performed. For example, as shown in FIG. 3A, at a timing t16, the image input interface circuit 110 may output the frame synchronization timing information FT after the frame data FD15 ends, and the image processor 130 may accordingly generate the statistical data SD5 based on the frame data FD15 and store the statistical data SD5 to a corresponding position in the data storage circuit 135 according to the address information SA corresponding to the statistical data SD5. In one embodiment, after the frame data FD15 is generated, the image sensor 101 enters an idle state and does not immediately perform image capturing.

In operation S218, the processor 140 determines the exposure control parameter F6 according to the multiple sets of statistical data SD1 to SD5. In operation S219, the controller 120 outputs the exposure control parameter F6 to the image sensor 101, and increases the resolution and reduces the frame rate of the frame data generated by the image sensor 101. In operation S220, the image sensor 101 generates the frame data FD2 having a higher resolution according to the exposure control parameter F6 during the second period T2. For example, the processor 140 may determine the exposure control parameter F6 according to the multiple sets of statistical data SD1 to SD5 at a timing t17, and output the exposure control parameter F6 to the image sensor 101 via the controller 120 at a timing t18 and at the same time increase the frame resolution and reduce the frame rate of the image sensor 101. Thus, the image sensor 101 may generate the frame data FD2 having a higher resolution according to the exposure control parameter F6 during the second period T2 after the timing t19.

As shown in FIG. 3A, each of the multiple sets of frame data FD11 to FD15 generated during the first period T1 has the same frame interval FI1, which is less than a frame interval FI2 of the frame data FD2 generated during the second period T2. In other words, the frame rate of each of the multiple sets of frame data FD11 to FD15 is greater than the frame rate of the frame data FD2. Moreover, because the resolution of the image sensor 101 is increased in operation S220, the resolution of each of the multiple sets of frame data FD11 to FD15 is lower than the resolution of the frame data FD2.

With the configuration above, the image processing device 100 is capable of quickly generating the multiple sets of frame data FD11 to FD15 having a lower resolution during the first period T1 after it is powered on, so as to reduce the data size of the multiple sets of frame data FD11 to FD15 and more quickly determine the multiple sets of corresponding statistical data SD1 to SD5. Thus, the processing efficiency for determining the exposure control parameter F6 can be improved, allowing the image processing device 100 to then more quickly control the image sensor 101 to generate the frame data FD2 having luminance appropriate for the current scene according to the appropriate exposure control parameter F6 and a higher resolution.

In some related art, an image processing device first controls an image sensor to generate data of a first frame, and determines a new exposure control parameter according to the data of the first frame and a target luminance value. Next, the image processing device configures the image sensor by using the new exposure control parameter, so as to control the image sensor to continue to generate data of a second frame according to the frame rate same as that of the data of the first frame and the resolution same as that of the data of the first frame and determine a new exposure control parameter according to the data of the second frame and the target luminance value. Next, the image processing device configures the image sensor according to the new exposure control parameter, so as to control the image sensor to continue to generate data of a third frame according to the same frame rate and the same resolution. Thus, by iterating the operations above, the image processing device can provide final generated frame data having luminance information that meets requirements of the target luminance. However, the related art above requires a lower frame rate and a higher resolution to continually generate data of multiple frames in order to have the luminance value of contents of an image approximate the target luminance value, resulting in more time needed to determine an appropriate exposure parameter. Compared to the technique above, in some embodiments of the present application, the image processing device 100 is capable of quickly generating multiple sets of frame data FD11 to FD15 (respectively corresponding to the different predetermined exposure control parameters F1 to F5) according to a higher frame rate (that is, a lower frame interval) and a lower resolution by controlling the image sensor 101 according to multiple sets of different predetermined exposure control parameters during a first period T1 after being powered on, and determining the appropriate exposure control parameters F6 based on the frame data FD11 to FD15. Thus, the overall time needed for determining the exposure control parameter in an early stage can be significantly reduced, thereby improving the processing efficiency for determining the exposure parameter.

FIG. 3B shows a schematic diagram of generating waveforms of the multiple sets of frame data FD11 to FD15 in FIG. 1 according to some embodiments of the present application. As described above, in the example in FIG. 3A, each of the multiple sets of frame data FD11 to FD15 has the same frame interval FI1 (that is, having the same frame rate) as one another. Different from FIG. 3A, in the example in FIG. 3B, at least two of the multiple sets of frame data FD11 to FD15 have frame rates different from each other. For example, according to the configuration of the controller 120, the image sensor 101 generates the frame data FD14 having a frame interval FI3 and the frame data FD15 having a frame interval FI4, wherein the frame interval FI4 is greater than the frame interval FI3, and the frame interval FI3 is greater than the frame interval FI1. In some embodiments, according to actual application requirements or different scenario requirements, the controller 120 may extend the corresponding exposure time by extending the frame interval of each of the multiple sets of frame data FD11 to FD15. As shown in FIG. 3B, compared to the frame data FD11 to FD13, an exposure time ET4 of the frame data FD14 and an exposure time ET5 of the frame data FD15 are longer. In other words, in this example, the frame rate of each of the multiple sets of frame data FD11 to FD13 is higher than the frame rate of the frame data FD14 and the frame rate of the frame data FD14 is higher than the frame rate of the frame data FD15. Hence, it should be understood that, the frame interval and the exposure time of each of the multiple sets of frame data FD11 to FD15 generated during the first period T1 may be adjusted according to actual requirements, and are not limited to being configured as shown in FIG. 3A and FIG. 3B.

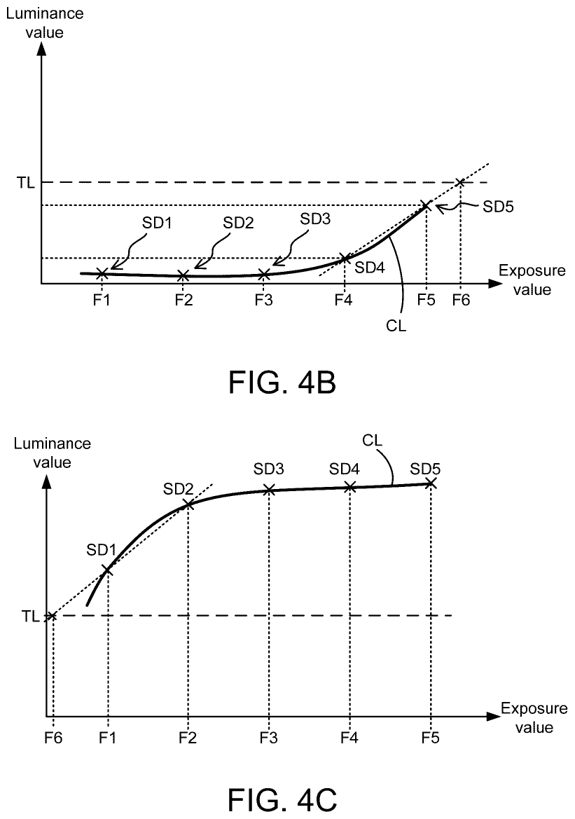

FIG. 4A shows a schematic diagram of a linear interpolation operation performed according to the multiple sets of statistical data SD1 to SD5 by the processor 140 in FIG. 1 according to some embodiments of the present application. As shown in FIG. 4A, the multiple sets of statistical data SD1 to SD5 correspond to the multiple predetermined exposure control parameters F1 to F5, respectively, wherein the exposure values corresponding to the multiple predetermined exposure control parameters F1 to F5 are from low to high. For example, the exposure times corresponding to the multiple predetermined exposure control parameters F1 to F5 may be from short to long, or the gains of the corresponding image sensor 101 (and/or the image processor 130) may be from low to high. In some embodiments, the exposure value above may be defined as a product of the exposure time and the gain of the image sensor 101 (and/or the image processor 130). In some embodiments, an upper limit of the gain of the image sensor 101 (and/or the image processor 130) may be defined according to actual application requirements (for example, noise performance). Correspondingly, the luminance values corresponding to the multiple sets of statistical data SD1 to SD5 are also from low to high.

In some embodiments, a luminance range covered by the multiple predetermined exposure control parameters F1 to F5 may be configured as about 16 dynamic ranges (for 16 exposure compensation values), which may cover from a darker shooting scene (for example, an indoor scene) to a brighter shooting scene (for example, an outdoor scene). With the configuration above, the multiple sets of statistical data SD1 to SD5 generated according to the plurality of predetermined exposure control parameters F1 to F5 may cover a greater number of applicable scenario range. In some embodiments, an interval between exposure values corresponding to two adjacent ones of the multiple predetermined exposure control parameters F1 to F5 is about 4 to 5 dynamic ranges (for exposure compensation values). In some embodiments, a luminance range covered by the multiple predetermined exposure control parameters F1 to F5 may be about 10 to 20 dynamic ranges (or exposure compensation values). In some embodiments, a luminance range covered by the multiple predetermined exposure control parameters F1 to F5 may be about 12 to 18 dynamic ranges (or exposure compensation values).

A curve CL in FIG. 4A can be obtained by connecting multiple luminance values corresponding to the multiple sets of statistical data SD1 to SD5, and the processor 140 may perform an auto exposure algorithm according to the multiple sets of statistical data SD1 to SD5 to determine an exposure control parameter needed for achieving a target luminance value TL. In this example, since the luminance distribution of the multiple sets of statistical data SD1 to SD5 is rather uniform, the target luminance value TL may usually be, for example but not limited to, an average value or a median value determined based on the multiple sets of statistical data SD1 to SD5. As shown in FIG. 4A, an intersection point of the target luminance value TL and the curve CL corresponds to the exposure control parameter F6. In some embodiments, the processor 140 may use at least two of the multiple sets of statistical data SD1 to SD5 to perform an interpolation operation (for example but not limited to, a linear interpolation operation) to estimate the exposure control parameter F6 corresponding to the intersection point. For example, the processor 140 may use the statistical data SD3 and the statistical data SD2 to perform a linear interpolation operation (an inner interpolation operation in this example) to determine the exposure control parameter F6.

FIG. 4B shows a schematic diagram of a linear interpolation operation performed according to the multiple sets of statistical data SD1 to SD5 by the processor 140 in FIG. 1 according to some embodiments of the present application. Different from FIG. 4A, in this example, since the luminance distribution of the multiple sets of statistical data SD1 to SD5 is concentrated in a lower luminance range, it means that the luminance of the current shooting scene may be lower. In this case, the processor 140 may set the target luminance value TL to a higher value, and use, among the multiple sets of statistical data SD1 to SD5, at least two that correspond to higher luminance values (for example, the statistical data SD4 and the statistical data SD5) to perform a linear interpolation operation (an extrapolation operation in this example) to estimate the exposure control parameter F6 corresponding to the intersection point.

FIG. 4C shows a schematic diagram of a linear interpolation operation performed according to the multiple sets of statistical data SD1 to SD5 by the processor 140 in FIG. 1 according to some embodiments of the present application. Different from FIG. 4A, in this example, since the luminance distribution of the multiple sets of statistical data SD1 to SD5 is denser in a higher luminance range, it means that the luminance of the current shooting scene may be higher. In this case, the processor 140 may set the target luminance value TL to a lower value, and use, among the multiple sets of statistical data SD1 to SD5, at least two that correspond to lower luminance values (for example, the statistical data SD1 and the statistical data SD2) to perform a linear interpolation operation (an extrapolation operation in this example) to estimate the exposure control parameter F6 corresponding to the intersection point.

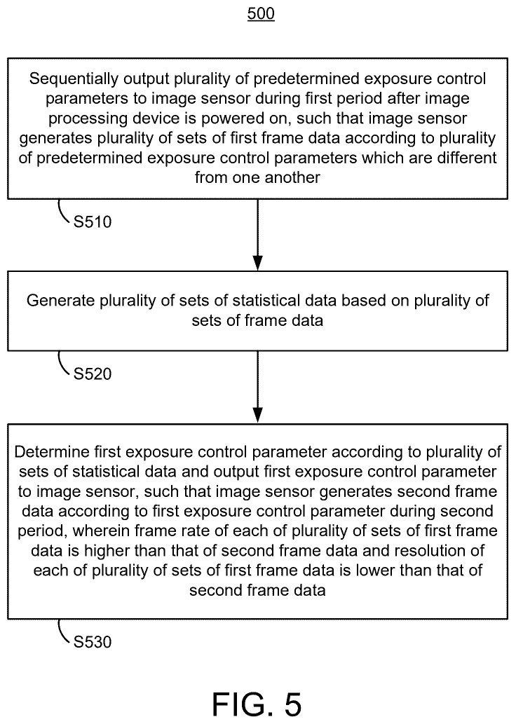

FIG. 5 shows a flowchart of an auto exposure control method 500 according to some embodiments of the present application. In some embodiments, the auto exposure control method 500 may be performed by, for example but not limited to, the image processing device 100 in FIG. 1.

In operation S510, a plurality of predetermined exposure control parameters are sequentially output to an image sensor during a first period after the image processing device is powered on, such that the image sensor generates a plurality of sets of first frame data according to the plurality of predetermined exposure control parameters, wherein the plurality predetermined exposure control parameters are different from one another. In operation S520, a plurality of sets of statistical data are sequentially generated based on the plurality of sets of first frame data. In operation S530, a first exposure control parameter is determined according to the plurality of sets of statistical data and the first exposure control parameter is output to the image sensor via the controller, such that the image sensor generates second frame data according to the first exposure control parameter during a second period. A frame rate of each of the plurality of sets of first frame data is higher than that of the second frame data, and a resolution of each of the plurality of sets of first frame data is lower than that of the second frame data.

Details associated with the multiple operations of the auto exposure control method 500 above can be referred from the details of the multiple embodiments above, and such repeated details are omitted herein. The multiple operations above are merely examples, and are not limited to being performed in the order specified in this example. Without departing from the operation means and ranges of the various embodiments of the present application, additions, replacements, substitutions or omissions may be made to the operations of the auto exposure control method 500, or the operations may be performed in different orders. Alternatively, all or some of one or more the operations in the auto exposure control method 500 may be performed simultaneously.

In conclusion, the image processing device and the auto exposure control method provided according to some embodiments of the present application are capable of generating multiple sets of frame data having a lower resolution and a higher frame rate according to multiple different predetermined exposure control parameters during a first period after the device is powered on, and accordingly determining an exposure control parameter appropriate for the current scene, so as to generate frame data having an appropriate luminance value according to the exposure control parameter during a subsequent perio. Thus, processing efficiency for auto exposure control can be improved so as to more quickly generate image data appropriate for the current scene.

While the present application has been described by way of example and in terms of the preferred embodiments, it is to be understood that the disclosure is not limited thereto. Various modifications may be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. An image processing device, comprising:
a controller, sequentially outputting a plurality of predetermined exposure control parameters to an image sensor during a first period after the image processing device is powered on, such that the image sensor generates a plurality of sets of first frame data according to the plurality of predetermined exposure control parameters, wherein the plurality of predetermined exposure control parameters are different from one another;
an image processor, generating a plurality of sets of statistical data based on the plurality of sets of first frame data; and
a processor, determining a first exposure control parameter according to the plurality of sets of statistical data and outputting the first exposure control parameter to the image sensor via the controller, such that the image sensor generates second frame data according to the first exposure control parameter during a second period,
wherein a frame rate of each of the plurality of sets of first frame data is higher than that of the second frame data, and a resolution of each of the plurality of sets of first frame data is lower than that of the second frame data.

2. The image processing device according to claim 1, further comprising:
a command storage circuit, storing a plurality of predetermined commands,
wherein the controller executes the plurality of predetermined commands to sequentially output the plurality of predetermined exposure control parameters to the image sensor during the first period.

3. The image processing device according to claim 2, further comprising:
an image input interface circuit, receiving the plurality of sets of first frame data from the image sensor and outputting the plurality of sets of first frame data to the image processor, and providing frame synchronization timing information associated with each of the plurality of sets of first frame data according to the plurality of first frame data to the controller,
wherein the controller further sequentially executes the plurality of predetermined commands according to the frame synchronization timing information.

4. The image processing device according to claim 2, further comprising:
a data storage circuit, storing the plurality of sets of statistical data,
wherein the controller executes the plurality of predetermined commands during the first period to sequentially output address information for storing a corresponding one of the plurality of sets of statistical data in the data storage circuit to the image processor.

5. The image processing device according to claim 1, wherein the image processor performs a luminance statistics operation according to the plurality of sets of first frame data, so as to determine luminance information of the plurality of sets of first frame data and accordingly generate the plurality of sets of statistical data.

6. The image processing device according to claim 1, wherein the processor performs an interpolation operation according to the plurality of sets of statistical data to determine the first exposure control parameter.

7. The image processing device according to claim 1, wherein frame rates of at least two of the plurality of sets of first frame data are different from each other.

8. An auto exposure control method, performed by an image processing device, the auto exposure control method comprising:
sequentially outputting a plurality of predetermined exposure control parameters to an image sensor during a first period after the image processing device is powered on, such that the image sensor generates a plurality of sets of first frame data according to the plurality of predetermined exposure control parameters, wherein the plurality predetermined exposure control parameters are different from one another;
sequentially generating a plurality of sets of statistical data based on the plurality of sets of first frame data; and
determining a first exposure control parameter according to the plurality of sets of statistical data and outputting the first exposure control parameter to the image sensor, such that the image sensor generates second frame data according to the first exposure control parameter during a second period,
wherein a frame rate of each of the plurality of sets of first frame data is higher than that of the second frame data, and a resolution of each of the plurality of sets of first frame data is lower than that of the second frame data.

9. The auto exposure control method according to claim 8, wherein the sequentially outputting the plurality of predetermined exposure control parameters to the image sensor during the first period after the image processing device is powered on comprises:
executing a plurality of predetermined commands to sequentially output the plurality of predetermined exposure control parameters to the image sensor during the first period.

10. The auto exposure control method according to claim 8, wherein the determining the first exposure control parameter according to the plurality of sets of statistical data comprises:
performing an interpolation operation according to the plurality of sets of statistical data to determine the first exposure control parameter.
